(19) United States
(12) Patent Application Publication
(10) Pub. No.: US 2006/0147299 A1
(43) Pub. Date: Jul. 6, 2006

(54) Shround cooling assembly for a gas trubine

(76) Inventor: Piero Iacopetti, Uzzano (IT)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/532,451

(22) PCT Filed: Nov. 13, 2003
(86) PCT No.: PCT/EP03/12827

§ 371 Date: Dec. 22, 2005

(30) Foreign Application Priority Data
Nov. 15, 2002 (IT) MI2002A002418

(51) Int. Cl. F03B 11/00

(52) U.S. Cl. 415/115

(57) ABSTRACT

An improved assembly (110) consisting of internal casing (112) and support device (114) for nozzles in a gas turbine stage, these nozzles being grouped together in sectors and each of these sectors being connected externally to an external casing of the gas turbine by means of the support device (114), this support device (114) being kept in position by the internal casing (112), there also being formed first cooling holes (122) on the internal casing (112) and second cooling holes (124) on the support device (114); the first cooling holes (122) of the internal casing (112) have an extension substantially parallel to the axis of the gas turbine.

The present invention relates to an improved assembly consisting of internal casing and support device for nozzles in a gas turbine stage.

In particular, this improved assembly is used in a first high-pressure stage of a gas turbine.

As is known, gas turbines are machines consisting of a compressor and a turbine with one or more stages, where these components are connected together by a rotating shaft and where a combustion chamber is provided between the compressor and the turbine.

In these machines, air from the external environment is supplied to the compressor in order to pressurise it.

The pressurised air passes through a series of pre-mixing chambers which terminate in a converging portion and in each of which an injector feeds fuel which is mixed with the air to form an air and fuel mixture to be burned.

The fuel is introduced inside the combustion chamber and is ignited by means of suitable igniter plugs so as to produce the combustion which is aimed at causing an increase in temperature and pressure and therefore enthalpy of the gas.

At the same time, the compressor provides pressurised air which is directed both through the burners and through the jackets of the combustion chamber so that the abovementioned pressurised air is available for feeding the fuel.

Subsequently the high-temperature and high-pressure gas reaches, via suitable ducts, the different stages of the turbine which converts the enthalpy of the gas into mechanical energy available for a user.

For example, in two-stage turbines, the gas is treated in the first stage of the turbine under very high temperature and pressure conditions and undergoes a first expansion therein, while in the second stage of the turbine it undergoes a second expansion, under temperature and pressure conditions lower than the first conditions.

It is also known that, in order to obtain the maximum performance from a given gas turbine, it is necessary for the temperature of the gas to be as high as possible; however, the maximum temperature values which can be reached during use of the turbine are limited by the strength of the materials used.

The gas flow passes through a system of stator nozzles and rotor blades arranged in different stages of the gas turbine.

The first stage nozzle has the function of presenting the combusted-gas flow under suitable conditions at the first-stage rotor inlet.

The set of nozzles of a gas turbine stage is formed by an annular body which can in turn be divided into nozzle sectors, each sector being generally formed by nozzles defined or differentiated by laminae with a suitable wing profile.

This set of nozzles is constrained externally to the casing of the turbine and internally to a corresponding annular support, also called “internal casing”.

In this respect it should be noted that the stators are subject to high pressure loads due to the reduction in pressure between the nozzle inlet and outlet.

Moreover, the stators are subject to high temperature gradients due to the flow of hot gases from the combustion chamber and from the preceding stage and to the cold-air flows which are introduced inside the turbine in order to cool the parts which are most greatly stressed from a thermal and mechanical point of view.

In the known configurations, each nozzle sector is connected externally to the external casing by means of a sector support device known as a shroud.

These sector support devices or shrouds are kept in position by an internal casing which, with the aid of suitable grooves and pins as well as by means of an interlocking joint with the nozzles, prevents the movement thereof.

In the known solution of the art, the sector support devices or shrouds are cooled with the aid of cooling inserts brazed directly along the external diameter of the said sector support devices.

The axial thrust is absorbed entirely by an anti-rotational pin and cooling of the whole assembly is performed by means of holes provided on the internal casing and at the rear of the sector support devices or shrouds.

The object of the present invention is therefore that of overcoming the drawbacks mentioned above and in particular that of providing an improved assembly consisting of internal casing and support device for nozzles in a gas turbine stage, which allows a reduction in the operating temperature of the components of the said assembly, with a consequent greater duration of said components.

Another object of the present invention is that of providing an improved assembly consisting of internal casing and support device for nozzles in a gas turbine stage, which allows optimisation of the play between rotor and stator of the turbine, with a consequent increase in the performance characteristics of the machine.

Another object of the present invention is that of providing an improved assembly consisting of internal casing and support device for nozzles in a gas turbine stage, which is particularly reliable, simple and functional and has a relatively low cost.

These and other objects according to the present invention are achieved by providing an improved assembly consisting of internal casing and support device for nozzles in a gas turbine stage, as illustrated in Claim 1.

Further characteristic features of an improved system consisting of internal casing and support device for nozzles in a gas turbine stage are described in the claims below.

The characteristic features and advantages of an improved assembly consisting of internal casing and support device for nozzles in a gas turbine stage according to the present invention will emerge more clearly and obviously from the following description provided by way of a non-limiting example, with reference to the accompanying schematic drawings in which:

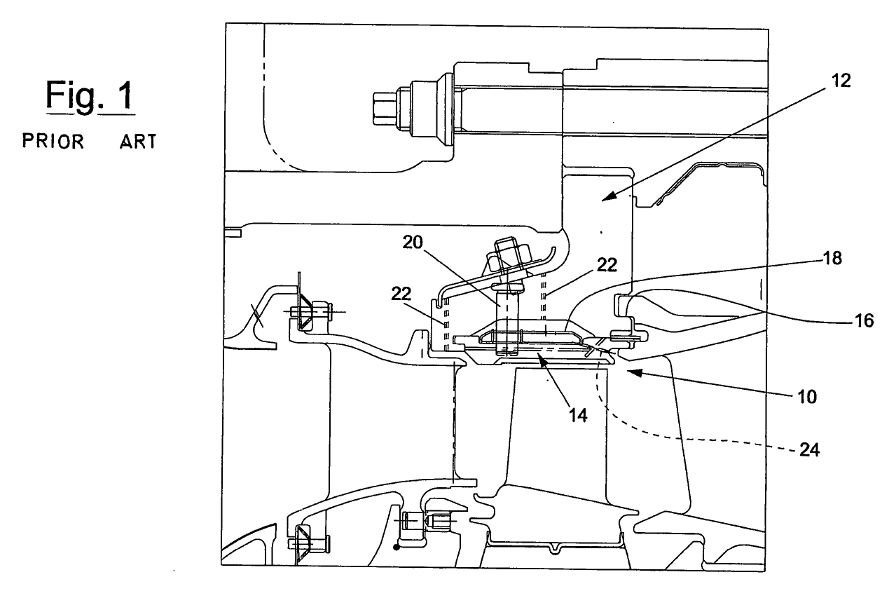

FIG. 1 is a cross-sectional side elevation view of an assembly consisting of internal casing and support device for nozzles in a gas turbine stage, according to the prior art;

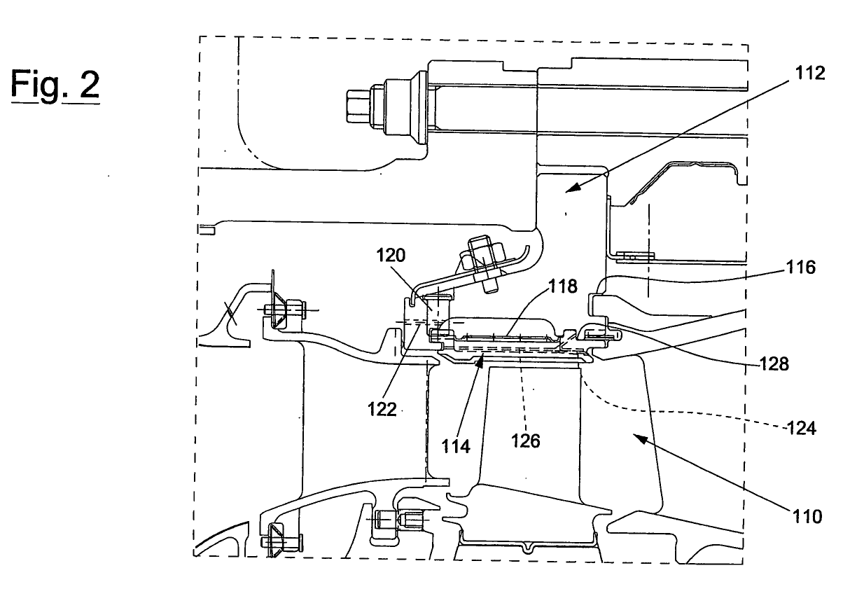

FIG. 2 is a cross-sectional side elevation view of an improved assembly consisting of internal casing and support device for nozzles in a gas turbine stage, according to the present invention.

With reference to FIG. 1, this figure shows an assembly—denoted overall by 10—consisting of internal casing 12 and support device 14 for nozzles in a gas turbine stage, according to the prior art.

Each nozzle sector is connected externally to the external casing of the gas turbine by means of the support device 14 which is of the sector type and called a “shroud”.

These sector support devices 14 or shrouds are kept in position by the internal casing 12 which, with the aid of suitable grooves and pins as well as by means of interlocking joints 16 with the said nozzles, prevents the movement thereof.

In the known solution shown in FIG. 1, the sector support devices or shrouds 14 are cooled with the aid of cooling inserts 18 brazed directly along an external diameter of the said sector support devices 14.

The axial thrust is absorbed entirely by an anti-rotational pin 20 and cooling of the entire assembly 10 is performed by means of first holes 22 provided on the internal casing 12 and second holes 24 arranged at the rear of the sector support devices or shrouds 14.

In particular, the first holes 22 are formed in directions substantially perpendicular to the axis of the gas turbine. Generally the first holes 22 are also inclined in the direction of the gas flow and have a diameter of about 1 mm. Advantageously two rows of these first holes 22 may be provided, resulting for example in a total of eighty-four first holes 22 for the entire internal casing 12.

FIG. 2 shows an improved assembly 110 consisting of internal casing 112 and support device 114 for nozzles in a gas turbine stage according to the present invention, in which the components which are identical and/or equivalent to those illustrated in FIG. 1 have the same reference numbers increased by 100.

In particular, each nozzle sector is connected externally to the external casing of the gas turbine by means of the sector support device or shroud 114.

These sector support devices or shrouds 114 are kept in position by the internal casing 112 which, with the aid of suitable grooves and pins as well as by means of interlocking joints 116 with the said nozzles, prevents movement thereof.

Cooling of the assembly 110 is performed by means of first holes 122 which are provided on the internal casing 112 and second holes 124 arranged at the rear of the sector support devices or shrouds 114.

More precisely, the first cooling holes 122 of the internal casing 112 have an extension substantially parallel to the axis of the gas turbine. These holes have a diameter greater than that of the first holes 22 used in the assembly 10 known in the art, for example 1.8 mm. Advantageously a circumferential series of these first holes 22 may be provided, resulting for example in a total of forty-two first holes 22 for the entire internal casing 112.

This therefore avoids the creation of gas turbulence due to a difference in pressure between the ends of the first holes 122, as instead occurred owing to the nature of the first holes 22 used in the prior art.

The sector support devices or shrouds 114 have, internally, a cooling recess 126: in this way the thicknesses are reduced and, with the aid of the cooling inserts 118 brazed directly along an external diameter of the said sector support devices 114, the operating temperatures are reduced and optimised.

An anti-rotational pin 120 is located further upstream compared to the location of the anti-rotational pin 20 used in the prior art, substantially at the front of the sector support devices or shrouds 114.

The axial thrust is no longer supported by the anti-rotational pin 120, but a contact surface 128 exists between internal casing 112 and support device 114 which reduces in turn the leaks present in this zone.

Advantageously, the improved assembly 110 consisting of internal casing 112 and support device 114 according to the invention may be used for the first high-pressure stage of a gas turbine.

The description provided clearly reveals the characteristic features as well as the advantages of the improved assembly consisting of internal casing and support device for nozzles in a gas turbine stage according to the present invention.

The following considerations and final comments are included here so as to define more precisely and clearly the abovementioned advantages.

Firstly it is pointed out that the improved assembly 110 illustrated in FIG. 2 results in lowering of the temperature of the two components consisting of internal casing 112 and sector support device or shroud 114, with a consequent greater duration of the said components and other neighbouring components. This reduction in temperature is obtained owing to the reduction in intake of hot gases from the channel where the gas passes.

Moreover, the improved assembly 110 consisting of internal casing 112 and support device 114 for nozzles in a gas turbine stage has resulted in the possibility of optimising the play existing between rotor and stator of the gas turbine, with a consequent increase in the machine performance characteristics.

It must also be remembered that the improved assembly 110 consisting of internal casing 112 and support device 114 for nozzles in a gas turbine stage is particularly reliable and has limited costs compared to the prior art.

Finally it is clear that the improved assembly consisting of internal casing and support device for nozzles in a gas turbine stage thus conceived may be subject to numerous modifications and variants, all falling within the invention; moreover all the details may be replaced by technically equivalent elements. Basically the materials used, as well as the forms and dimensions, may be of any nature according to the technical requirements.

The scope of protection of the invention is therefore delimited by the accompanying claims.

1. Improved assembly (110) consisting of internal casing (112) and support device (114) for nozzles in a gas turbine stage, said nozzles being grouped together in sectors and each of said sectors being connected externally to an external casing of said gas turbine by means of said support device (114), said support device (114) being kept in position by said internal casing (112), there also being formed first cooling holes (122) on said internal casing (112) and second cooling holes (124) on said support device (114), characterized in that said first cooling holes (122) of said internal casing (112) have an extension substantially parallel to the axis of said gas turbine.

2. Improved assembly (110) according to claim 1, characterized in that said support device (114) has internally a cooling recess (126).

3. Improved assembly (110) according to claim 1, characterized in that cooling inserts (118) are provided in said support devices (114).

4. Improved assembly (110) according to claim 3, characterized in that said cooling inserts (118) are brazed along an external diameter of said support devices (114).

5. Improved assembly (110) according to claim 1, characterized in that an anti-rotational pin (120) is provided, being located substantially at the front of said support device (114).

6. Improved assembly (110) according to claim 1, characterized in that a contact surface (128) supporting an axial thrust exists between said internal casing (112) and said support device (114).

7. Improved assembly (110) according to claim 1, characterized in that said support devices (114) are grouped together in sectors.

8. Improved assembly (110) according to claim 1, characterized in that said support devices (114) are kept in position by said internal casing (112) by means of grooves and pins and interlocking joints (116) with said nozzles.

9. Improved assembly (110) according to claim 1, characterized in that said second cooling holes (124) are arranged at the rear of said support device (114).

10. Improved assembly (110) according to claim 1, characterized in that said first holes (122) are arranged circumferentially and are forty-two in number.

11. Improved assembly (110) according to claim 1, characterized in that said first holes (122) have an approximate diameter of 1.8 mm.

12. Improved assembly (110) according to claim 1, characterized in that said stage is the first high-pressure stage of a gas turbine.
